(19) United States
(12) Patent Application Publication
(10) Pub. No.: US 2025/0245036 A1
(43) Pub. Date: Jul. 31, 2025

(54) System and Method for Transparent Memory Compression

(71) Applicant: Dell Products L.P., Round Rock, TX (US)

(72) Inventor: Dmitry Krivenok, Dublin (IE)

(21) Appl. No.: 18/427,360

(22) Filed: Jan. 30, 2024

(51) Int. Cl. G06F 9/455

(52) U.S. Cl. CPC G06F 9/45558; G06F 9/45554; G06F 2009/45583

(57) ABSTRACT

A method, computer program product, and computing system for implementing transparent memory compression. A system for implementing memory compression, includes a host device and a plurality of micro virtual machines on the host device, each micro virtual machine including an application running thereon. An application monitor monitors operation of each application to ascertain memory use characteristics of each application and determines a memory compression mechanism suitable for compressing memory used by each application based on the ascertained memory characteristics.

### BACKGROUND

Technologies exist that enable transparent memory compression at the system level, in which multiple applications running either directly on a host or inside containers on top of a container runtime on a host device. However, such technologies operate only at the system level through the same OS kernel that resides on the host. This means that the systems are not able to control compression at the application level, which yields suboptimal results when performance varies between the applications running on the host and each application requires a different set of compression rules to operate in an efficient manner.

### SUMMARY OF DISCLOSURE

In one example implementation, a system for implementing memory compression includes a host device and a plurality of micro virtual machines on the host device, each micro virtual machine including an application running thereon. An application monitor is configured to monitor operation of each application to ascertain memory use characteristics of each application and to determine a memory compression mechanism suitable for compressing memory used by each application based on the ascertained memory characteristics.

One or more of the following example features may be included. The system may include a hypervisor on which the plurality of micro virtual machines operate. At least one of the applications may be configured to run on a container runtime. Each micro virtual machine may include a guest operating system (OS) kernel. The memory use characteristics may include at least one of memory accesses by the application and memory compressibility. The memory compression mechanism may include memory compression on the host. The memory compression mechanism may include memory compression on the guest OS of the micro virtual machine. Memory compression may be performed by a CPU of the host. Memory compression may be performed by a hardware accelerator. Each guest OS may include memory swap functionality. The memory compression mechanism may include one of a tiered zram swap, a non-tiered zram swap, an SSD swap, and no memory compression.

In another example implementation, a computer program product resides on a computer readable medium that has a plurality of instructions stored on it. When executed by a processor, the instructions cause the processor to perform operations that may include, but are not limited to, monitoring operation of each of a plurality of applications running in an associated micro virtual machine residing on a host, ascertaining memory use characteristics of each application, and determining a memory compression mechanism suitable for compressing memory used by each application based on the ascertained memory characteristics.

One or more of the following example features may be included. Each micro virtual machine may include a guest operating system (OS) kernel. The memory use characteristics may include at least one of memory accesses by the application and memory compressibility. The memory compression mechanism may include memory compression on the host. The memory compression mechanism may include memory compression on the guest OS of the micro virtual machine.

In another example implementation, a computing system includes a memory and a processor configured to perform operations that may include, but are not limited to, monitoring operation of each of a plurality of applications running in an associated micro virtual machine residing on a host, ascertaining memory use characteristics of each application, and determining a memory compression mechanism suitable for compressing memory used by each application based on the ascertained memory characteristics.

One or more of the following example features may be included. Each micro virtual machine may include a guest operating system (OS) kernel. The memory use characteristics may include at least one of memory accesses by the application and memory compressibility. The memory compression mechanism may include memory compression on the host.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a virtual entry lifetime expansion process coupled to a distributed computing network according to one or more example implementations of the disclosure;

FIG. 2 is an example depiction of a system for implementing memory compression;

FIG. 3 is an example depiction of a system for implementing memory compression accordance with an implementation of the disclosure; and

FIG. 4 is an example flowchart of the memory compression process according to one or more example implementations of the disclosure.

Like reference symbols in the various drawings indicate like elements.

### DETAILED DESCRIPTION

### System Overview:

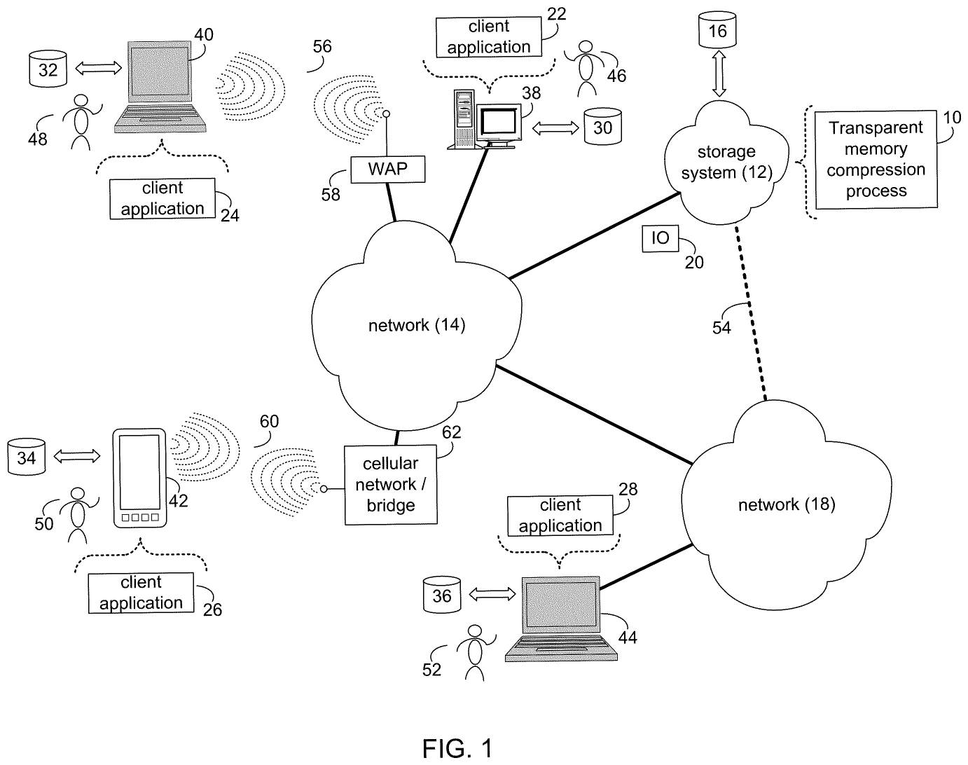

Referring to FIG. 1, there is shown transparent memory compression process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of Transparent memory compression process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of disability access assistance process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Transparent Memory Compression Process:

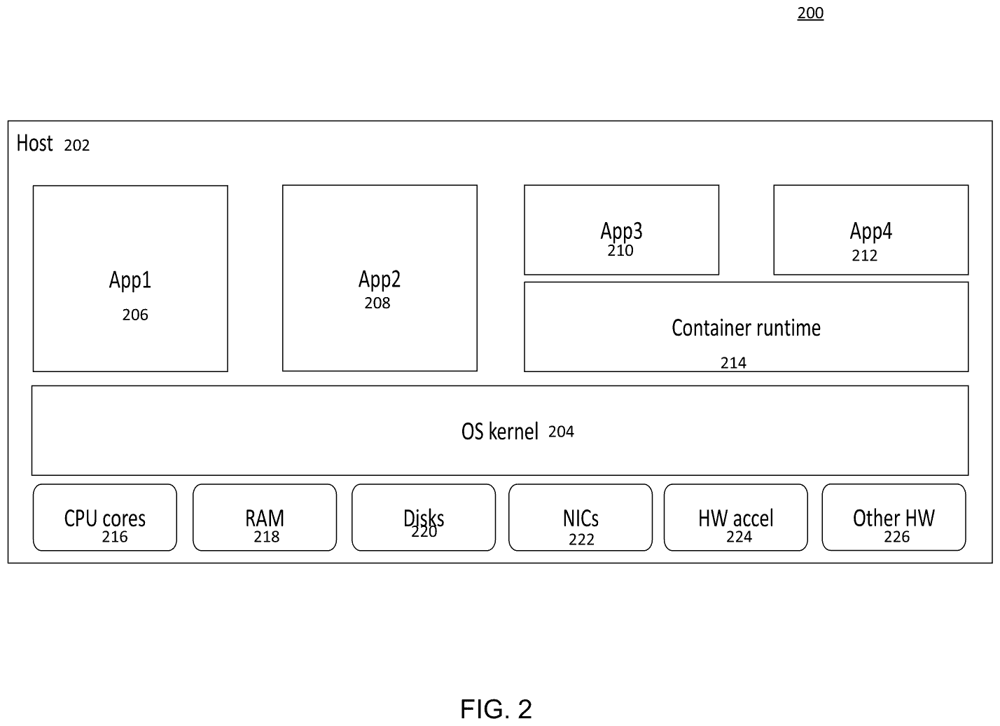

FIG. 2 is an example graphical representation of a server system 200 for implementing memory compression. Server system 200 includes a host 202, an operating system kernel 204 on which a number of applications 206, 208, 210, and 212 run. Applications 210 and 212 are containerized and run on container runtime 214. Host 202 also includes CPU cores 216, RAM 218, hard drive disks 220, NICs 222, Hardware accelerator(s) 224, and other hardware 226 used by the applications and OS for carrying out various functions.

FIG. 2 illustrates a typical server system running heterogeneous applications 206, 208, 210, and 212. Those applications may run directly or inside containers on top of a container runtime 214. All applications 206, 208, 210, and 212 share the same OS kernel 204. Each application 206, 208, 210, and 212 consumes memory and has unique application-specific access patterns and memory compressibility characteristics. The total amount of RAM in the server limits the number of applications that may be run on it. Existing technologies support partitioning of memory between applications and containers via technologies like cgroups. Such technologies also enable system-wide swapping backed by compressed memory.

The main issue with server system 200 is that those technologies yield suboptimal results due to lack of application awareness. As a result, servers are often overprovisioned and run less applications than would be possible without impacting application performance. This is becoming even more serious problem because current servers are often equipped with HW acceleration for compression (e.g., Intel QAT or IAA) further reducing the performance overhead of memory compression.

There are multiple technologies which enable transparent memory compression at system level, for example Linux zram or zswap. Their downside is that they do not allow control compression at application level. It's not possible to enable/disable compression for a particular application (other than locking all pages in memory), there is no way to use different compression algorithms per application, there is no way to transparently enable HW accelerated compression via technologies like Intel QAT or IAA for specific application, etc. There are many applications which are designed to work with data structures compressed in memory, for example in-memory databases. Such applications may leverage application specific knowledge of compressibility of data and efficiently use available CPU and HW acceleration resources. The problem is that implementation is application specific and cannot be used for other applications in a transparent way, i.e., without modifying the applications and adding explicit support of memory compression.

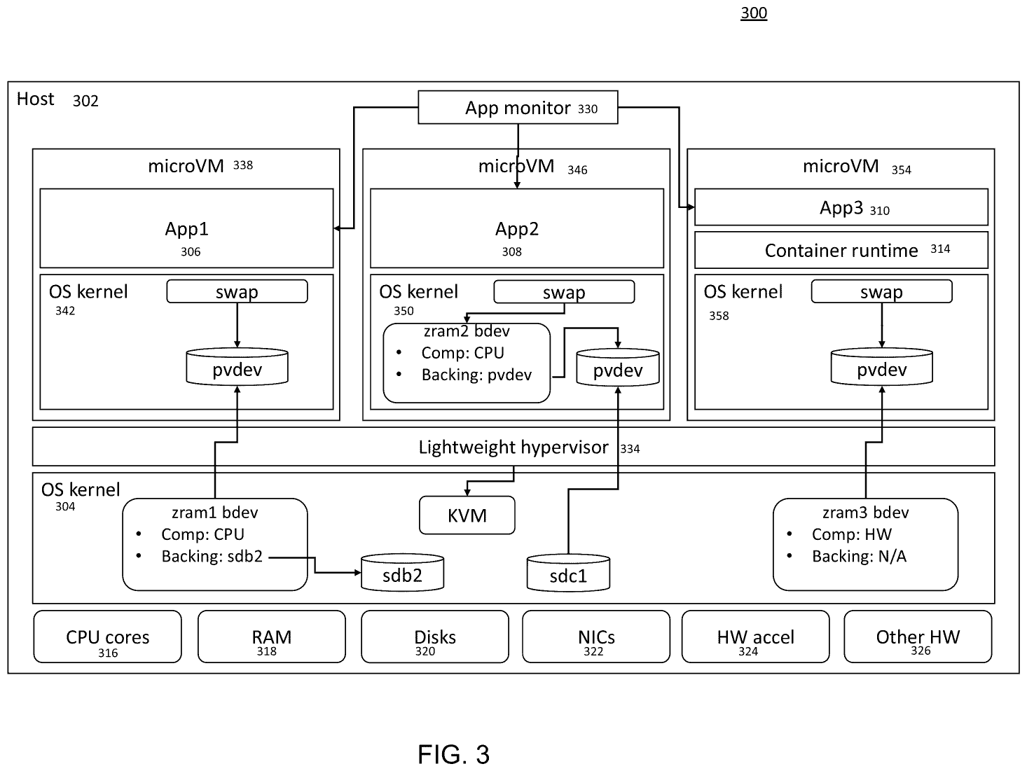

Referring now to FIG. 3, an implementation of the disclosure of a server system 300 will be described. Server system 300 includes a host 302 running an OS kernel 304. Host 302 includes a plurality of micro virtual machines (microVM) 338, 346, and 354 on which applications 306, 308, and 310, respectively, run. Application 310 runs on a container runtime 314.

A microVM or micro virtual machine, is a lightweight and highly efficient form of virtualization that provides a minimalistic virtualization environment for running isolated workloads. MicroVMs are designed to have a small footprint and low overhead, making them ideal for deploying and managing microservices, containerized applications, or serverless functions. They offer the benefits of isolation, resource control, and scalability while minimizing the performance impact typically associated with traditional virtual machines.

MicroVM 338 includes a guest OS kernel 342, microVM 346 includes a guest OS kernel 350, and microVM 354 includes a guest OS kernel 358. MicroVM 338, microVM 346, and microVM 354 run on lightweight hypervisor 334. Host 302 also includes CPU cores 316, RAM 318, hard drive disks 320, NICs 322, hardware accelerator(s) 324, and other hardware 326 used by the applications and OS for carrying out various functions.

Also included on host 302 is application monitor 330 which monitors memory access patterns, for example memory idle time, and memory compressibility characteristics of application 306, application 308, and application 310. Application monitor 330 operates to identify applications which will benefit from transparent memory compression and decide what will be the right mechanism for such compression. It may run in both test/dev and production environment.

Application monitor 330 obtains information about application memory accesses via OS interfaces by clearing the page table entry (PTE) “accessed” bit. A Page Table Entry (PTE) is a data structure used by the operating system's memory management to map virtual addresses to physical addresses. Each entry in the page table corresponds to a specific page or block of memory and contains information about the corresponding virtual-to-physical address mapping. In a virtualized environment where multiple virtual machines share the same physical hardware, the hypervisor may use the “accessed” bit to monitor the memory usage of each virtual machine. This information can be used for making decisions about allocating and reclaiming physical memory.

Operation of the application monitor 330 is transparent to the applications 306, 308, and 310, as application monitor 330 does not need to know about details of the applications and therefore coarse-grained OS APIs are sufficient to do the job. For example, on Linux the bits may be cleared via /proc/pid/clear_refs API. Once cleared, application monitor 330 starts monitoring page references over time via APIs such as Linux /proc/pid/smaps. Application monitor 330 may also monitor memory compressibility via the following methods:
Switch app to custom memory allocator via LD_PRELOAD and mmap compressed memory device such as zram. Then monitor compressibility statistics during the workload.
Switch app to custom memory allocator via LD_PRELOAD and mmap a sparse file. Run the workload and analyse file content using different compression algorithms.
Run workload and force core dump at different moments. Parse and compress core dump content using different compression algorithms.
   The choice of the method is dictated by different factors such as whether the application is running in test/dev or production environment, the duration of the workload, etc.

App monitor gathers statistics and then configured a memory compression mechanism for each application. The following Table 1 shows how various combinations of idle memory levels and memory compressibility determine which memory compression mechanism is utilized for each application.

TABLE 1

| | Idle memory | Compressibility | Mechanism |
|---|---|---|---|
| 1 | High | Low | SSD swap |
| 2 | High | High | Tiered zram swap |
| 3 | Medium | Low | Tiered zram swap |
| 4 | Medium | High | Tiered zram swap |
| 5 | Low | Low | No compression |
| 6 | Low | High | Non-tiered zram swap |
| | | | w/HW offload |

The ranges indicated in Table 1 (“High”, “Medium”, “Low”) are relative and depend on the application being monitored and the system on which the application is running. For example, in one implementation, a compression value greater that 4:1 may be considered to be high compressibility, and a compression value less than 4:1 may be considered to be low compressibility.

If memory is constantly referenced (low idle memory) and isn't compressible (low compressibility), then there is no benefit in performing compression because that will only introduce compute and memory (metadata) overhead. This corresponds to Row 5 in Table 1.

If memory is constantly referenced (low idle memory), but pages may be compressed well (high compressibility), then the decision for most applications will be transparent memory compression with hardware acceleration. This corresponds to Row 6 in Table 1.

If memory is mostly idle (high idle memory) and does not compress well (low compressibility), it could be inefficient to compress memory and idle pages may be swapped out to SSD storage. This corresponds to Row 1 in Table 1. In some scenarios SSD swap may introduce too high latency, e.g., in application startup/initialization phase. In this case, app monitor may fall back to tiered zram swap (see below).

In all other cases (high idle memory/high compressibility—Row 2; medium idle memory/low compressibility—Row 3; medium idle memory/high compressibility—Row 4) application monitor 330 utilizes a tiered zram swap mechanism. If hardware acceleration is available, then some applications may use accelerated zram (applications with lower idle memory may be prioritized if hardware offload resources are limited on the host).

zram is a Linux kernel module that provides a compressed block device in RAM. The purpose of ‘zram’ is to improve system performance by allowing compressed data storage in RAM, reducing the need to swap data to slower disk-based swap spaces. zram takes a portion of the system's RAM and compresses the data stored in it. Compression helps to fit more data into the allocated space, effectively increasing the amount of usable RAM. zram creates block devices (/dev/zram0, /dev/zram1, etc.) that can be used like any other block device on the system. These devices are where the compressed data is stored. zram is also used as a swap device, providing an alternative to traditional swap space on the hard disk. When the system needs to swap out data (move data from RAM to disk to free up space), zram can provide a faster solution as it operates in RAM, which is significantly faster than accessing data on a disk. The size of the zram block devices can be dynamically adjusted based on system requirements. This allows the system to adapt to varying workloads.

As mentioned above, all apps 306, 308, 310 are running on the same host and share the underlying OS kernel 304 regardless of being containerized or not. In order to enable the application monitor 330 to work at the application level to determine the appropriate memory compression mechanism for each application, each application runs inside a microVM running on top of lightweight hypervisor 334. Multiple such hypervisors are available today, e.g., cloud-hypervisor, firecracker, and others. They are designed to run a single application, container, or pod with primary focus on security and isolation. This is achieved though running each application 306, 308, 310 inside its own microVM 338, 346, 354, respectively, each with different guest OS kernel 342,350, 358. Each MicroVM 338, 346, 354 runs minimalistic guest OS 342, 350, 358 with a majority of functionality disabled in the kernel and user-space. They are designed to start up very quickly and introduce minimal performance impact on a single application running inside.

Each microVM guest OS kernel 342, 350, 358 includes swapping and compressed memory support enabled. Compressed memory swap device will be exposed from the host to microVM guest as block device via standard paravirtual block drivers. Application monitor 330 configures each such device differently depending on the application (e.g., different compression algorithm may be used for different applications). Each zram block device is a thinly provisioned in-memory block device backed by compressed memory pages. This device may have an optional second-tier device, normally residing on local SSD, intended for memory pages which are either non-compressible or idle for very long times. One example of such device is Linux kernel zram driver, though similar devices available in other OSs may be used.

Each microVM 338, 346, 354 is running with vCPU cores and some amount of RAM determined by the application monitor 330. vCPU (virtual Central Processing Unit) refers to a virtualized instance of a physical CPU that is allocated to a virtual machine (VM) by a hypervisor in a virtualized environment. Each vCPU represents a portion of the physical CPU's computing resources that are dedicated to a specific VM. vCPUs enable the simultaneous execution of multiple virtual machines on a single physical server, allowing for efficient utilization of computing resources. This memory is required by the guest OS itself as well as the application. Swapping is enabled on a designated block device exposed to the microVM which automatically expands available memory capacity as visible by the application. The microVM OS kernel 342, 350, 358 utilizes standard swapping implementation to swap out least recently used (LRU) pages to the swap device and swap them back in when they are needed. The compression happens transparently within the host OS kernel 342, 350, 358 by means of a zram driver (compression is done either on CPU, as shown in connection with microVM 338 and microvisor 346, or is offloaded to HW accelerator, as shown in connection with microVM 354).

The above-described memory compression process allows two possible configurations for memory compression:
1. The first configuration is to perform memory compression on the host, as shown in connection with applications 306 and 310.
2. The second configuration is to perform memory compression inside guest OS of microVM as shown in connection with application 308.

Application monitor 330 determines which configuration to use for a particular application depending on several factors. One important factor is access to HW acceleration. If available, it can be more efficient to run zram with HW acceleration on the host. Another important factor is the overhead introduced by paravirtual block driver of the microVM. The overhead can depend on a particular host OS, lightweight hypervisor, and guest OS in use. If the overhead may be too high, then application monitor 330 may decide to forego HW accelerated compression and perform compression inside microVM instead.

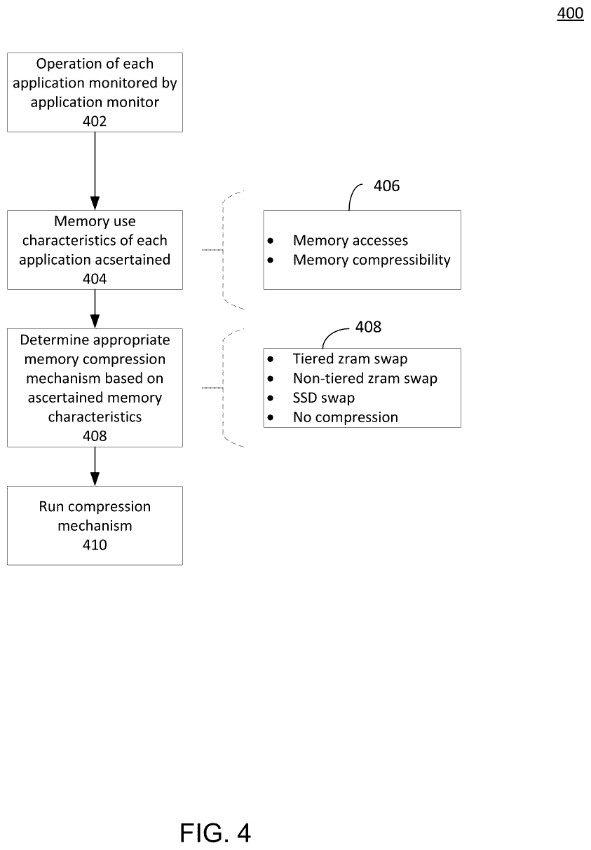

Referring to FIG. 4, a flowchart 400 of the memory compression process will be described. As set forth above the operation of each application 306, 308, 310 running in its own microVM 338, 346, 354 on the host 302 is monitored by application monitor 330, 402. Memory use characteristics are ascertained by the application monitor, 404. The memory use characteristics include, memory access (or idle memory) and memory compressibility, 406. Application monitor determines an appropriate memory compression mechanism based on the ascertained memory characteristics, 408. The memory compression mechanisms include a tired zram swap, a non-tiered zram swap, an SSD swap, or no compression, 408. The determined compression mechanism is then run with the application, 410.

Accordingly, implementations of the disclosure provide a system for transparent memory compression that operates at the application level, such that the compression for each application is determined based on memory characteristics of each application. This approach allows for higher density of applications per server and ability to run the same heterogeneous workloads on server with lower amount of memory. Implementations of the disclosure do not require modification of the applications or detailed in-depth knowledge of application's memory layout or access patterns. In other words, the compression mechanism is application-specific but done transparently to the applications. Application monitor 330 assures that each application's memory will be compressed in the most effective way considering observed memory access patters, memory compressibility, available HW acceleration, among other factors.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A system for implementing memory compression, comprising:
a host device;
a plurality of micro virtual machines on the host device, each micro virtual machine including an application running thereon; and
an application monitor configured to monitor operation of each application to ascertain memory use characteristics of each application and to determine a memory compression mechanism suitable for compressing memory used by each application based on the ascertained memory characteristics.

2. The system for implementing memory compression of claim 1 further including a hypervisor on which the plurality of micro virtual machines operate.

3. The system for implementing memory compression of claim 2 wherein at least one of the applications is configured to run on a container runtime.

4. The system for implementing memory compression of claim 2 wherein each micro virtual machine comprises a guest operating system (OS) kernel.

5. The system for implementing memory compression of claim 2 wherein the memory use characteristics include at least one of memory accesses by the application and memory compressibility.

6. The system for implementing memory compression of claim 1 wherein the memory compression mechanism comprises memory compression on the host.

7. The system for implementing memory compression of claim 4 wherein the memory compression mechanism comprises memory compression on the guest OS of the micro virtual machine.

8. The system for implementing memory compression of claim 1 wherein memory compression is performed by a CPU of the host.

9. The system for implementing memory compression of claim 1 wherein memory compression is performed by a hardware accelerator.

10. The system for implementing memory compression of claim 4 wherein each guest OS includes memory swap functionality.

11. The system for implementing memory compression of claim 1 wherein the memory compression mechanism comprises one of a tiered zram swap, a non-tiered zram swap, an SSD swap, and no memory compression.

12. A computer program product residing on a non-transitory computer readable medium having a plurality of instructions stored thereon which, when executed by a processor, cause the processor to perform operations comprising:
monitoring operation of each of a plurality of applications running in an associated micro virtual machine residing on a host;
ascertaining memory use characteristics of each application; and
determining a memory compression mechanism suitable for compressing memory used by each application based on the ascertained memory characteristics.

13. The computer program product of claim 12 wherein each micro virtual machine comprises a guest operating system (OS) kernel.

14. The computer program product of claim 13 wherein the memory use characteristics include at least one of memory accesses by the application and memory compressibility.

15. The computer program product of claim of claim 12 wherein the memory compression mechanism comprises memory compression on the host.

16. The computer program product of claim of claim 13 wherein the memory compression mechanism comprises memory compression on the guest OS of the micro virtual machine.

17. A computing system comprising:
a memory; and
a processor configured to:
monitor operation of each of a plurality of applications running in an associated micro virtual machine residing on a host;
ascertain memory use characteristics of each application; and
determine a memory compression mechanism suitable for compressing memory used by each application based on the ascertained memory characteristics.

18. The computer program product of claim 17 wherein each micro virtual machine comprises a guest operating system (OS) kernel.

19. The computer program product of claim 17 wherein the memory use characteristics include at least one of memory accesses by the application and memory compressibility.

20. The computer program product of claim of claim 17 wherein the memory compression mechanism comprises memory compression on the host.
